(19) United States
(12) Patent Application Publication
(10) Pub. No.: US 2004/0204152 A1
(43) Pub. Date: Oct. 14, 2004

(54) Signal-sensing device for a cellular phone

(76) Inventors: Chin-Yeh Chang, Taichung (TW); Kenichi Kizuka, Ibaraki (JP)

Correspondence Address: Kuo-Hsiung Chiu, 13F., No.23, Jiun-Ho Street, Peitun District, Taichung, 406, TW

(21) Appl. No.: 10/341,267

(22) Filed: Jan. 14, 2003

(51) Int. Cl. H04Q 7/32

(52) U.S. Cl. 455/567; 455/100; 455/575.1

(57) ABSTRACT

The present invention relates to a signal-sensing device for a cellular phone having a fixing wrist strap and respective pivoting members. The cellphone is worn on the wrist or the chest so as to eliminate the trouble to take out and return the cellphone and to allow a rapid and easy operation thereof. In addition, the electromagnetic action instead of the complicated and unbalanced vibration produced by the prior art motor type vibrator is utilized to generate attracting and repelling effect. Accordingly, the production cost can be effectively reduced. Meanwhile, an exact vibration signal can be given out as well. Moreover, the noise can be eliminated. Besides, when the cellphone is removed for charging in the charger, a normal ringing sound can be produced due to the electric connection between the cellphone and the charger.

### BACKGROUND OF THE INVENTION

1. Field of the Invention

The present invention relates to a signal-sensing device for a cellular phone, and more particularly, to a device that is worn on the wrist or in front of the chest.

By means of the intermittent signals, an electromagnetic apparatus of a vibration generator produces magnetic field. Therefore, an induction coil and a magnet are attracted to each other or repelled away from each other, thereby creating vibration to allow the user to be notified of an incoming call.

2. Description of the Prior Art

Normally, the cellular phone is placed in a handbag or the pocket of clothes. In order to receiving an incoming call or to make a phone call, it's necessary for the user to perform the tedious and annoying process of taking out or returning it. Moreover, the cellphone can slip off the hand and fall to the ground, thereby leading to the damage of the cellphone. Most cellphone users must have such experiences.

The conventional cellphone is provided with vibration alert feature in which a motor works with an eccentric shaft for enlarging the amplitude of vibration so as to notify the user of an incoming call. However, this mechanism increases the dimension of the cellphone instead of minimization of the volume thereof. In addition, the production cost of the cellphone can be raised.

Furthermore, cellphones may come across as a nuisance when they ring in clubs, hospitals, libraries, or a quiet work place in general where a ringing phone can not be heard. And the users are often confused with the same ringing sound. Accordingly, the notifying way of incoming calls has to be improved.

### SUMMARY OF THE INVENTION

It is a primary object of the present invention to remove the above-mentioned drawbacks and to provide a signal-sensing device for a cellular phone which is partly in contact with the user's body. Therefore, the trouble of taking-out and returning action is eliminated in receiving an incoming call or making a phone call, thereby facilitating the use of the cellphone.

Due to the close contact of the cellphone with the user's body, a slight vibration can be sensed. Therefore, it's necessary to install complicated mechanism (like motor type vibrator) in the cellphone. The vibration of the present invention is generated in such a way that an induction coil and a magnet are attracted to each other or repelled away from each other. Accordingly, it's not required to install a ringing device when the cellphone is placed on the user's body.

In addition, the cellphone can be removed from the user's body for charging. The charger has ringing function as normal cellphone. Thus, the present invention can be conveniently used round the clock. Besides, the battery can be charged every day so that it can be minimized and light-weight.

### BRIEF DESCRIPTION OF THE DRAWINGS

The accomplishment of this and other objects of the invention will become apparent from the following description and its accompanying drawings of which:

FIG. 1 is a sectional view of a vibration generator of the present invention;

FIG. 2 is a sectional view of another embodiment of the vibration generator of the present invention;

FIG. 3 is a perspective view of the present invention with a wrist strap extending around the wrist.

### DETAILED DESCRIPTION OF THE PREFERRED EMBODIMENT

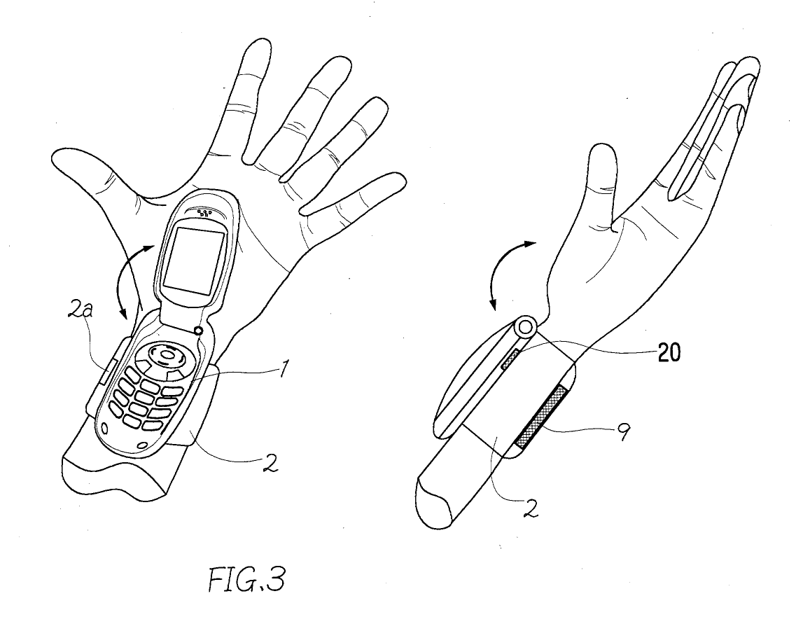

First of all, referring to FIGS. 1 and 3, a detailed view of the vibration generator is shown.

The cellphone 1 is in contact with the inside of wrist. One side of the cellphone 1 is pivotably connected with a wrist strap 2 by a swivel pin 8. The wrist strap is extended around the wrist. Moreover, the wrist strap 2 has a protrusion 2a that is engaged into a corresponding recessed member 1a so that the cellphone 1 can be fixed on the wrist.

In the vibration generator 20, a coil 4 on a coil rack 3 is fixed at the inner side 1b of the contact surface of the cellphone 1 with the wrist.

The center of the coil 4 has a small hole 3a on the coil rack 3. Shaft-shaped iron rod or magnet 5 is inserted into the small hole 3a. A metal disc 7 and a spring coil 6 are fixed at one side of the iron rod or magnet 5. The iron rod or magnet 5 is kept by the spring coil 6 at the center of the small hole 3a of the coil rack 3. The iron rod or magnet 5 is located within the small hole 3a for smooth movement.

In order to prevent the iron rod or magnet 5 and the metal disc 7 from being thrown away due to the repellent force of the spring coil 6, the ceiling 1c blocks up at the top.

When the incoming signal touches the coil 4, the coil 4 generates magnetic field to attract the iron rod or magnet 5 and the metal disc 7. Therefore, the front end of the iron rod or magnet 5 penetrates into the small hole 3a and gives impact on a small hole 1d of the cellphone 1. When the incoming signal stops, the magnetic field of the coil 4 disappears. Accordingly, the spring coil 6 brings the iron rod or magnet 5 back to its original position to give impact on the ceiling 1c of the cellphone 1.

When the signal comes again, the iron rod or magnet 5 penetrates by means of the magnetic field into the small hole 3a while giving impact on the small hole 1d. Thus, the user feels impact on his wrist. In case of signal stop, the impact is created as well. This slight vibration is enough to exactly produce vibration alert effect.

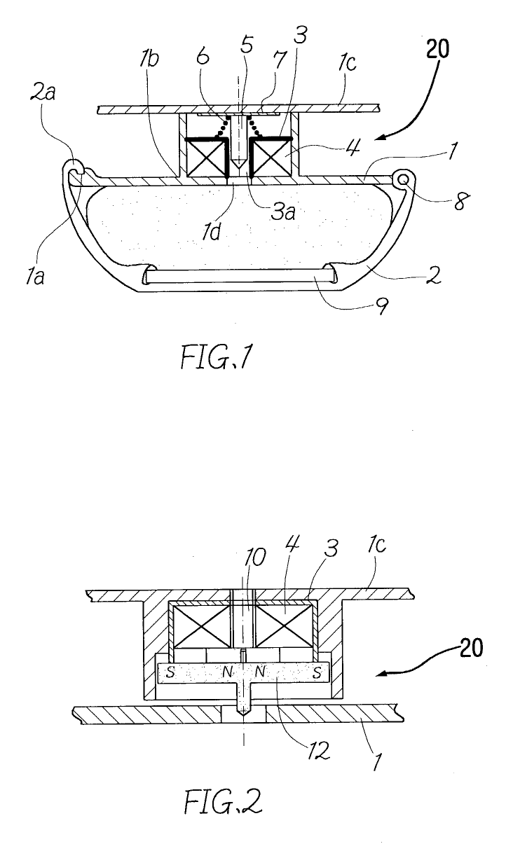

Referring to FIG. 2, another embodiment of the vibration generator 20 of the present invention is shown. The coil 4 and the coil rack 3 are disposed at a relative higher place. Then, a post 10 and a magnet 12 are used to produce the same electromagnetic action, thereby achieving an expected effect.

Based on the above-mentioned components, the light-weight and mini-type cellphone 1 of the present invention is preferably worn on the wrist or hangs on the neck.

The cellphone 1 is fixed on the wrist by a wrist strap 2 made of cloth, metal or resin as if it were a small decoration. In order to make the cellphone 1 slimmer, the battery 9 and the wrist strap 2 are constructed in a body and placed around the outer side of the wrist while the folding cellphone 1 is disposed at the inner side of the wrist. Consequently, both sides of the wrist are balanced.

In use, to open the folding cellphone 1 allows the LCD-panel and the receiver to be located on the palm of the hand. To move the hand to the ear enables the user to make an easy and rapid communication with the other party.

In addition, the vibration generator 20 in receiving signals is installed at the inner side of the cellphone housing in contact with the inner side of the wrist. Therefore, it's easy for the wrist to feel the vibration.

The hanging way is the same to the above-mentioned. The cellphone 1 in contact with the chest includes a vibration generator 20 at the inner side thereof. In receiving signals, the ringing is the same to that of the cellphone 1 placed on the wrist. The ringing device which is disposed within the charging device (not shown) and connected to the speaker of the cellphone 1 gives out tones. Therefore, the ringing sound is given out in receiving signals.

So, the cellphone 1 of the present invention can be easily fixed on the wrist or hung on the chest so as to minimize the vibration source of the sensing signals. Meanwhile, the price thereof can be lowered. Moreover, the trouble to take the cellphone 1 out of the handbag or packet can be eliminated, thereby allowing a rapid dialing and receiving telephone calls. Besides, the ringing sound can be avoided.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A signal-sensing device for a cellular phone comprising a fixing wrist strap and respective pivoting members for extending around the wrist or hanging in front of the chest whereby the electromagnetic action is utilized to generate attracting and repelling effect in such a way that a vibration generator creates a reciprocating movement for a slight impact such that the skin of the user in contact with the cellphone feels the vibration alert effect, thereby allowing the user to be notified of an incoming call.

2. A signal-sensing device for a cellular phone further comprising a vibration generator which includes:
a) a coil disposed on a coil rack and fixed at the inner side of the contact surface of the cellphone with the wrist;
b) a small hole disposed at the center of the coil and mounted on the coil rack;
c) a shaft-shaped iron rod or a magnet being inserted into the small hole;
d) a metal disc and a spring coil fixed at one side of the iron rod or the magnet which is kept by the spring coil at the center of the small hole of the coil rack, the iron rod or the magnet being located within the small hole for smooth movement;
whereby, when the incoming signal touches the coil, the coil generates magnetic field to attract the iron rod or the magnet and the metal disc such that the front end of the iron rod or magnet penetrates into the small hole and gives impact on the a small hole of the cellphone and when the incoming signal stops, the magnetic field of the coil disappears such that the spring coil brings the iron rod or magnet back to its original position to give impact on the ceiling of the cellphone, and
whereby, when the signal comes again, the iron rod or the magnet are attracted by means of the magnetic field to penetrate through the small hole, thereby giving impact on the small hole such that the user feels impact on his wrist and in case of signal stop the impact is created as well such that this so slight vibration can exactly produce vibration alert effect.

3. The signal-sensing device for a cellular phone of claim 2 wherein the coil and the coil rack are disposed at a relative higher place, whereupon a post and a magnet are used to produce the same electromagnetic action, thereby achieving an expected reciprocating vibration effect.
